(19) United States
(12) Patent Application Publication
(10) Pub. No.: US 2022/0173559 A1
(43) Pub. Date: Jun. 2, 2022

(54) Cordless Power Tool Battery Extension Connector

(71) Applicant: Salvatore Naimo, Bayside, NY (US)

(72) Inventor: Salvatore Naimo, Bayside, NY (US)

(21) Appl. No.: 17/535,993

(22) Filed: Nov. 27, 2021

Related U.S. Application Data
(60) Provisional application No. 63/198,981, filed on Nov. 28, 2020.

(51) Int. Cl. H01R 31/00; H02J 7/00; B25F 5/00

(52) U.S. Cl. CPC H01R 31/00; B25F 5/00; H02J 7/0045

(57) ABSTRACT

An apparatus, consisting of two adapter(s) connected to each end of a multi conductor power cord; by way a female adapter(s), that is connected to one end of the multi conductor power cord, connects to a conventional cordless power tool and the other male adapter(s), that is connected to the other end of the same multi conductor power cord, connects to a conventional battery pack; creating an extension between the cordless power tool and the battery pack, allowing the user to house the battery pack in a tool belt, or any other location the user may find convenient other than directly connected to the cordless power tool, so the weight and bulk of the battery is no longer in the user's hand; by way a larger sized battery pack can be used that holds more of a charge than a smaller battery pack, which makes the cordless power tool more powerful, longer lasting, and more efficient, while being much lighter and less cumbersome for the user to manage.

### BACKGROUND OF INVENTION

In the home improvement sector, it is a daunting process to operate corded power tools. There are many times, and needs, when a corded power tool is not feasible or efficient. However, cordless power tools have their limitations. Corded power tools can be cumbersome and dangerous due to the added risks of wires and extension cords needed to operate the tool. There are many times when a corded power tool is not practical or efficient. They are usually powered by cumbersome and heavy weighted battery packs that do not supply sufficient power and/or runtime that is required to complete a job. The battery packs needed to perform tasks that require great power, or lengthy powered time, are extremely heavy and bulky to operate, causing strain to the user. Contractors, or users of such cordless power tools, need to frequently charge battery packs in the middle of a job, causing loss of time that could be spent completing a job. The battery power always seems to run out just when you need it most. The biggest complaints users have when operating cordless power tools is the runtime, weight, bulkiness, and power of the battery pack. With the Cordless Power Tool Battery Extension Connector, these complaints are addressed and solved.

### SUMMARY OF INVENTION

The Cordless Power Tool Battery Extension Connector, the apparatus, consists of two adapter(s) connected to each end of a multi conductor power cord. One female adapter(s) connects to the cordless power tool, in place of the battery pack, and the other male adapter(s) connects to the battery pack. The Cordless Power Tool Battery Extension Connector, apparatus, creates an extension between the cordless power tool and the battery pack, similar to an extension cord, allowing the user to house the battery pack in a tool belt, or any other location the user may find convenient other than directly connected to the cordless power tool, so the weight and bulk of the battery is no longer in the user's hand. This allows for a larger sized battery pack(s) that can hold more of a charge, which makes the cordless power tool more powerful, longer lasting, and more efficient, while being much lighter and less cumbersome for the user to manage.

The conventional cordless power tool(s), which already exists in the market, will not require any alterations, nor will the battery pack that powers these cordless power tools. With the Cordless Power Tool Battery Extension Connector, the user has the ability to increase the power of the cordless power tool, while making the tool much lighter and less cumbersome, allowing the user to work smarter, not harder. The apparatus can be easily retrofitted to any cordless power tool in the market, without the use of other instruments and/or devices. The apparatus also allows for a more streamline, compact cordless power tool, which would make it much more comfortable for the user to handle. In addition, this apparatus will have minimal production and retail costs. The Cordless Power Tool Battery Extension Connector finally gives the user the ability to operate the cordless power tool with the power of a corded power tool, while maintaining a comparable weight, size, and runtime of the corded power tools.

### BRIEF DESCRIPTION OF THE INVENTION

A more complete appreciation of the invention and many more other intended advantages can be readily attained by reference to the following detailed description when considered in connection with the following drawings, wherein:

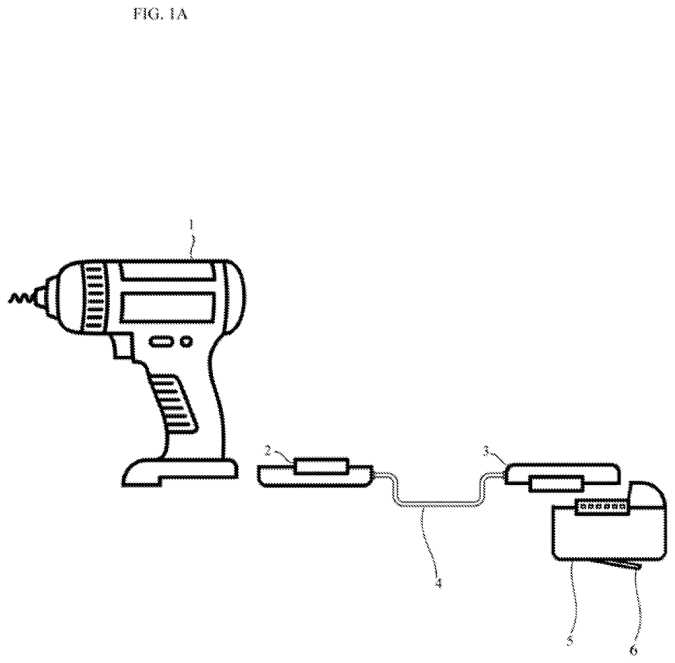

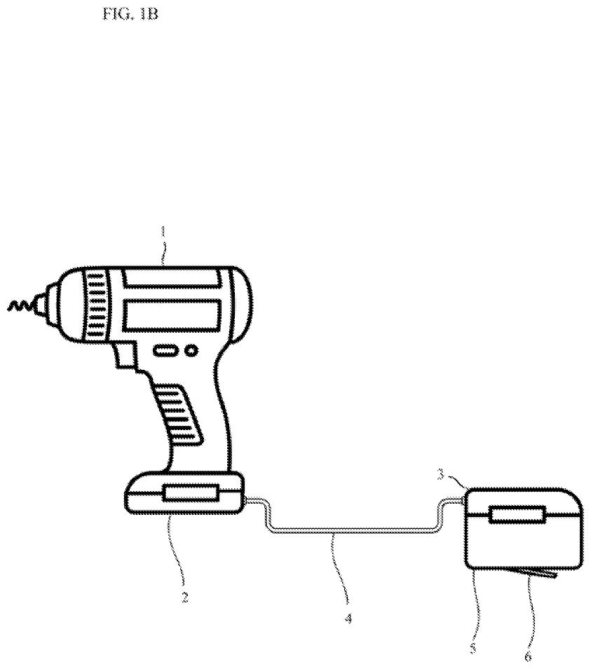

FIG. 1A is a perspective side view illustrating the use of the device of the present invention in combination with a conventional cordless power tool; this figure also illustrates a female adapter(s) that would connect to the cordless power tool by way of interlocking connection, a second male adapter(s) that would connect to a battery pack by way of interlocking connection, acting as an extension cord for the battery pack.

FIG. 1B is a perspective side view illustrating the use of the device of the present invention in combination with a conventional cordless power tool; this figure also illustrates a female adapter(s) that is connected to the cordless power tool by way of interlocking connection, a second male adapter(s) that would connect to a battery pack by way of interlocking connection, acting as an extension cord for the battery pack.

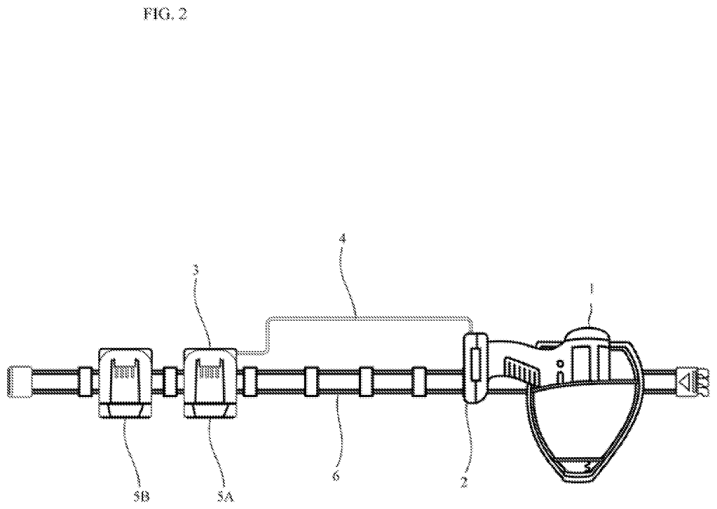

FIG. 2 is a perspective side view illustrating the use of the device of the present invention in combination with a conventional cordless power tool stored in a conventional tool belt worn by user of power tool and invention; this figure also illustrates a female adapter(s) that is connected to the cordless power tool by way of interlocking connection, connected to a second male adapter(s) by way of a multi conductor power cord, that would connect to a battery pack by way of interlocking connection; this figure also illustrates a second battery pack stored in the tool belt for added power.

### DETAILED DESCRIPTION OF THE PREFERRED EMBODIMENT

The device of the present invention is shown in FIG. 1A and FIG. 1B when used in combination with a conventional cordless power tool 1 in which the cordless power tool 1 is connected to a female adapter(s) 2 by way of interlocking connection. Female adapter(s) 2 is connected to male adapter(s) 3 by way of conventional multi conductor power cord 4. Male adapter(s) 3 is connected to a conventional battery pack 5. A clip 6 is demonstrated and can be used on the battery pack 5 for easy storage to a conventional tool belt and/or another easily accessible placement.

The device of the present invention is also shown in FIG. 2 as it would be stored in a conventional tool belt 6 worn by the user. The cordless power tool 1 is stored in the pocket of the tool belt 6 while the male adapter(s) 3 and battery pack 5A and 5B are attached to the tool belt 6 by way of clip or pocket. As presented in FIG. 1A and FIG. 1B, the device of the present invention is shown in FIG. 2 when used in combination with a conventional cordless power tool 1 in which the cordless power tool 1 is connected to a female adapter(s) 2 by way of interlocking connection. Female adapter(s) 2 is connected to male adapter(s) 3 by way of conventional multi conductor power cord 4. Male adapter(s) 3 is connected to a conventional battery pack 5. Also depicted in FIG. 2 is a secondary battery pack 5B, as multiple battery packs can be used in conjunction with adapter(s) 3 to provide additional power and battery life to the cordless power tool 1.

### DESCRIPTION OF PARTS FOR NUMBERS OF CORDLESS POWER TOOL BATTERY EXTENSION CONNECTOR

1. CORDLESS POWER TOOL
2. FEMALE ADAPTER(S)
3. MALE ADAPTER(S)
4. MULTI CONDUCTOR POWER CORD
5. BATTERY PACK
6. CLIP

What is claimed is an apparatus consisting of:

1. Female adapter(s); locks into cordless pool, in place of conventional battery pack;
connects to one side of multi conductor power cord.

2. Male adapter(s); connects to female adapter(s) by way of multi conductor power cord;
locks into battery pack by way of interlocking connection, essentially acting as an extension cord for battery pack, in order for the user to store the battery pack in a place other than the cordless power tool.

3. Multi conductor power cord that connects a female adapter(s) to male adapter(s).
